(19) United States
(12) Patent Application Publication
(10) Pub. No.: US 2008/0223998 A1
(43) Pub. Date: Sep. 18, 2008

(54) Display Device and Support Stand Therefor

(76) Inventors: Won-Kyu Bang, Suwon-si (KR); Ki-Jung Kim, Suwon-si (KR); Se-II Oh, Suwon-si (KR)

Correspondence Address: CHRISTIE, PARKER & HALE, LLP, PO BOX 7068, PASADENA, CA, 91109-7068, US

(21) Appl. No.: 12/127,778

(22) Filed: May 27, 2008

Related U.S. Application Data
(62) Division of application No. 10/934,038, filed on Sep. 3, 2004.

(30) Foreign Application Priority Data
Sep. 4, 2003 (KR) 2003-0061842

(51) Int. Cl. F16M 11/00

(52) U.S. Cl. 248/176.1

(57) ABSTRACT

A support stand for a display device includes a chassis base, a display panel, a connecting member, a stand member, and a shock absorbing member. The display panel is attached to the chassis base, and the connecting member is coupled to the chassis base. The stand member is connected to the connecting member such that the stand member supports the chassis base to which the display panel is attached. The shock absorbing member is disposed between the connecting member and the stand member such that the shock absorbing member absorbs a shock caused by a collision between the connecting member and the stand member.

### CROSS-REFERENCE TO RELATED APPLICATION(S)

This application is a Divisional of U.S. patent application Ser. No. 10/934,038 filed on Sep. 3, 2004 which application claims priority to and the benefit of Korean Patent Application No. 2003-0061842 filed on Sep. 4, 2003 in the Korean Intellectual Property Office, the entire content of which is incorporated herein by reference.

### FIELD OF THE INVENTION

The present invention relates to a display device and a support stand therefor, and more particularly, to a plasma display device support stand having a stand member at a lower portion thereof such that it can stably stand upright.

### BACKGROUND OF THE INVENTION

Generally, a plasma display device displays images on a plasma display panel (hereinafter referred to as a PDP) using plasma generated by the discharge of gas.

Such a plasma display device may include a PDP, a chassis base that is disposed parallel to the PDP, a heat transferring medium that is disposed between the PDP and the chassis base and which contacts the PDP, and driving circuits that are mounted on a surface of the chassis base which drive the PDP. A front case is coupled at the side of the PDP, and a back case is coupled to the side of the driving circuits.

In order to support such a plasma display device, a stand guide is coupled to a lower portion of the chassis base. A stand bar is inserted into a receiving hole of the stand guide and is coupled to the stand guide with a bolt. A lower portion of the stand bar is integrally coupled to a stand base, and the stand base contacts a bottom surface so that the plasma display device can stand upright.

Generally, the size of the plasma display device is greater than 40 inches and is very heavy. Therefore, while inserting the stand bar into the receiving hole of the stand guide and moving the assembled plasma display device, there can be a collision between the stand bar and the stand guide, the impact of which can be transferred to the plasma display panel via the chassis base so that the PDP can be damaged or a dark point can be formed thereon.

### SUMMARY OF THE INVENTION

In accordance with the present invention a support stand for display devices is provided in which a shock caused as a result of a collision between a stand bar and a stand guide can be decreased.

A display device is provided which includes a chassis base, a display panel, a connecting member, a stand member, and a shock absorbing member. The display panel is attached to the chassis base, and the connecting member is coupled to the chassis base. The stand member is connected to the connecting member such that the stand member supports the chassis base to which the display panel is attached. The shock absorbing member is disposed between the connecting member and the stand member such that the shock absorbing member absorbs a shock by a collision between the connecting member and the stand member.

In one exemplary embodiment, the connecting member is a stand guide having a receiving hole that is opened in a downward direction, and the stand member includes a stand base and a stand bar, an upper portion of which is inserted into the receiving hole of the stand guide and a lower portion of which is coupled to the stand base.

In a further exemplary embodiment, the shock absorbing member is disposed between an upper surface of the receiving hole and an upper surface of the stand bar. Further, the shock absorbing member may be coupled to the upper surface of the stand bar through a coupling member.

In another exemplary embodiment, a hanging step is formed on the stand bar, and the shock absorbing member is disposed between the hanging step and a bottom surface of the stand guide. Further, the shock absorbing member may have a ring shape.

In a further embodiment, an upper surface of the receiving hole and an upper surface of the stand bar are distanced from each other.

Moreover, the connecting member may be coupled to a surface of the chassis base that is opposite to a surface of the chassis base to which the display panel is attached.

Additionally, the shock absorbing member may be made of a rubber material.

### BRIEF DESCRIPTION OF THE DRAWINGS

FIG. 1 is a perspective view of a display device according to an embodiment of the present invention.

FIG. 2 shows a partial side cross-sectional view of the display device of FIG. 1.

FIG. 3 shows a partial side cross-sectional view of a display device according to another embodiment of the present invention.

FIG. 4 is an exploded perspective view of a stand bar, a stand guide, and a shock absorbing member of the display device of FIG. 3.

### DETAILED DESCRIPTION

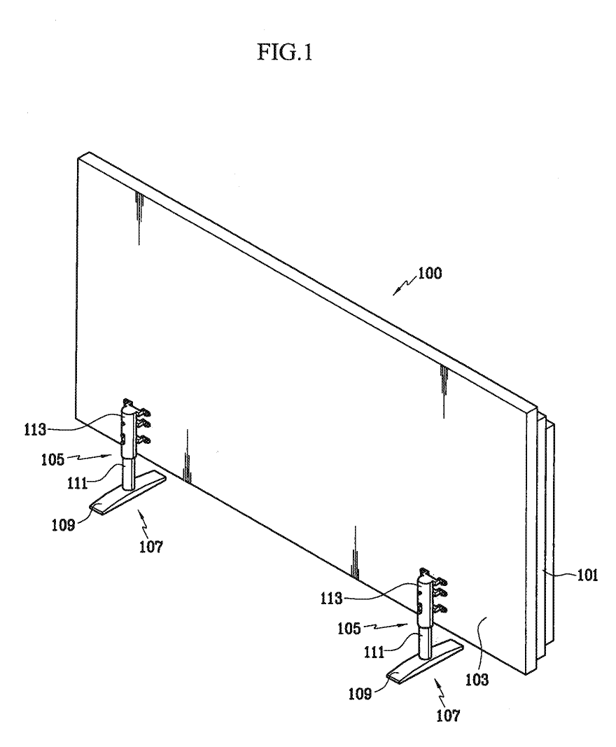

As shown in FIG. 1, a plasma display device 100 according to an embodiment of the present invention comprises a plasma display panel (PDP) 101, and the plasma display panel 101 is attached to a front surface of a chassis base 103. The plasma display panel 101 can be attached to the chassis base 103 through any attaching member (e.g., an adhesive heat spreading sheet, a double-sided adhesive tape, or the like). Thus, the chassis base supports the plasma display panel 101, and it also absorbs heat that is generated by the plasma display panel 101 and dissipates the heat to atmosphere. Therefore, it is preferable that the chassis base 103 is made of a material having good physical strength and good heat conductivity.

A heat transferring layer (not shown) may be disposed between the chassis base 103 and the plasma display panel 101. Driving circuits (not shown) for driving the plasma display panel 101 may be mounted on a rear surface of the chassis base 103.

The plasma display device 100 according to one embodiment of the present invention includes a connecting member 105, which is coupled to a lower portion of the rear surface of the chassis base 103 that is opposite to a surface to which the plasma display panel is attached, and a stand member 107 that is connected to the connecting member 105 and supports the chassis base 103 to which the plasma display panel 101 is attached.

The stand member 107 may be a combination of a stand base 109 and a stand bar 111 that is upwardly extended from the stand base 109, and the connecting member 105 may be a stand guide 113 that can be connected with the stand bar 111.

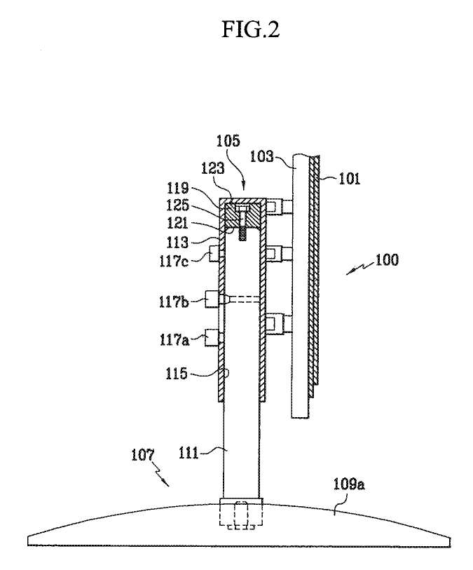

As shown in FIG. 2, the stand guide 113 includes a receiving hole 115 that is opened in a downward direction, and as shown in the drawing, the stand bar 111 is inserted into the receiving hole 115. The stand bar 111 is fixedly coupled to the stand guide 113 through coupling members 117a, 117b, and 117c, such as bolts.

As further shown in FIG. 2, the plasma display device 100 according to the embodiment of the present invention comprises a shock absorbing member 119 that is disposed between the connecting member 105 and the stand member 107 such that the shock absorbing member 119 absorbs a shock by an insertion collision between the connecting member 105 and the stand member 107.

The shock absorbing member 119 can be made of any material that can be deformed in response to a shock and that can absorb the shock. As an example, the shock absorbing member 119 can be made of a rubber material or a high-density polyurethane such as a BUMPON®.

As also shown in FIG. 2, the shock absorbing member 119 is disposed at an upper portion of the stand bar 111. That is, the shock absorbing member 119 is disposed between an upper surface 121 of the stand bar 111 and an upper surface 123 of the receiving hole 115. Here, the upper surface 123 of the receiving hole 115 means an upper portion of an inner surface of the stand guide 113 defining the receiving hole 115.

Therefore, when the stand bar 111 is inserted into the receiving hole 115 of the stand guide, the shock absorbing member 119 can decrease (be compressed) to absorb a shock as a result of a collision between the stand bar 111 and the stand guide 113.

In an exemplary embodiment, the shock absorbing member 119 is coupled to the upper surface 121 of the stand bar 111 through a coupling member 125 such as a bolt. Instead of a bolt, any coupling member such as a bonding agent can be used for coupling the shock absorbing member 119 to the stand bar 111.

In another exemplary embodiment, an upper surface of the coupling member 125 is lower than an upper surface of the shock absorbing member 119 such that the upper surface of the coupling member 125 does not directly collide with the stand guide 113.

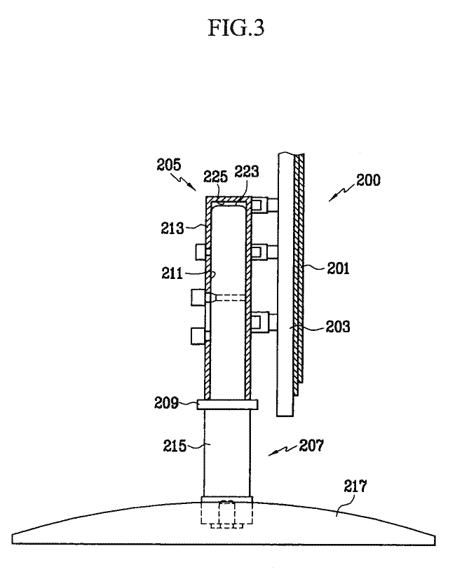

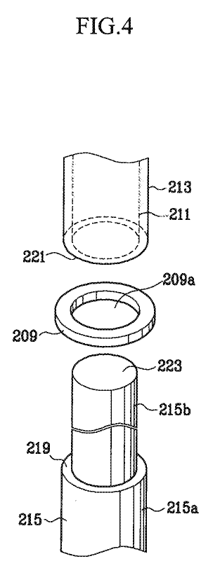

Referring to FIGS. 3 and 4, a plasma display device 200 according to another embodiment of the present invention is explained.

As shown in FIG. 3, the plasma display device 200 according to this embodiment of the present invention comprises a plasma display panel 201, a chassis base 203, a connecting member 205, a stand member 207, and a shock absorbing member 209.

The connecting member 205 can be a stand guide 213 including a receiving hole 211 that is opened in a downward direction, and the stand member 207 can be a combination of a stand bar 215, an upper portion of which is inserted into the receiving hole 211, and a stand base 217 to which a lower portion of the stand bar 215 is coupled.

As shown in FIG. 4, the stand bar 215 is stepped such that a hanging step 219 is formed. That is, the stand bar 215 includes a lower portion 215a and an upper lower portion 215b that have different thicknesses.

A through hole 209a is formed at a center portion of the shock absorbing member 209, so that the shock absorbing member 209 has a ring shape. The upper portion 215b of the stand bar 215 is inserted into the through hole 209a of the shock absorbing member 209 and is hung on the hanging step 219. In this state, the upper portion 125b of the stand bar 215 is inserted into the receiving hole 211 of the stand guide 213. That is, the shock absorbing member 209 is disposed between the hanging step 219 and a bottom surface 221 of the stand guide 213.

Therefore, when the stand bar 215 is inserted into the stand guide 213, a shock by a collision between the stand bar 215 and the stand guide 213 can be absorbed by the shock absorbing member 209.

At this time, an upper surface 223 of the stand bar 215 and an upper surface 225 of the receiving hole 211 are distanced from each other by a predetermined distance, so that the stand bar 215 can be prevented from directly colliding with the stand guide 213.

Although exemplary embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

The plasma display device according to the embodiments of the present invention includes the shock absorbing member that is disposed between the stand guide and the stand bar, so that a shock that can be generated while inserting the stand bar into the stand guide or while moving the plasma display device can be decreased.

While embodiments have been described with regard to plasma display panels, those skilled in the art can appreciate that the support stand can also be used with other flat panel display devices such as liquid crystal displays, organic electroluminescent displays, field emission displays and the like.

What is claimed is:

1. A display device, comprising:
a chassis base having a front surface and a rear surface;
a display panel coupled to the front surface;
a connecting member coupled to the rear surface;
a stand member insertable into the connecting member for supporting the chassis base; and
a shock absorbing member within the connecting member and between the connecting member and the stand member, whereby the shock absorbing member absorbs a shock from an insertion collision between the connecting member and the stand member,
wherein the connecting member is a stand guide comprising a receiving hole opened in a downward direction, and wherein the stand member comprises a stand base and a stand bar, the stand bar having an upper portion insertable into the receiving hole of the stand guide and a lower portion coupled to the stand base, and
wherein a hanging step is formed on the stand bar, and wherein the shock absorbing member is disposed between the hanging step and a bottom surface of the stand guide.

2. The display device of claim 1, wherein the shock absorbing member has a ring shape.

3. The display device of claim 1, wherein an upper surface of the receiving hole and an upper surface of the stand bar are distanced from each other.

4. The display device of claim 1, wherein the connecting member is coupled to a surface of the chassis base that is opposite to a surface of the chassis base to which the plasma display panel is attached.

5. The display device of claim 1, wherein the shock absorbing member is made of a rubber material.

6. The display device of claim 1, wherein the display panel is a plasma display panel.

7. A support stand for display devices comprising:
a chassis base having a front surface and a rear surface, the front surface being attachable to a display panel;
a connecting member coupled to the rear surface, the connecting member comprising a stand guide including a receiving hole and a stand guide upper surface;
a stand member comprising a stand base, and a stand bar extending from the stand base and insertable into the receiving hole, the stand bar comprising a stand bar upper surface; and
a shock absorbing member between the stand guide upper surface and the stand bar upper surface for absorbing a shock from an insertion collision between the connecting member and the stand member.

8. The support stand of claim 7, wherein the connecting member is a stand guide comprising a receiving hole opened in a downward direction, and wherein the stand member comprises a stand base and a stand bar, the stand bar having an upper portion of which is insertable into the receiving hole of the stand guide and a lower portion of which is coupled to the stand base.

9. The support stand of claim 7, wherein the shock absorbing member is coupled to the stand bar upper surface by a coupling member.

10. The support stand of claim 8, wherein a hanging step is formed on the stand bar, and wherein the shock absorbing member is disposed between the hanging step and a bottom surface of the stand guide.

11. The support stand of claim 10, wherein the shock absorbing member has a ring shape.

12. The support stand of claim 10, wherein an upper surface of the receiving hole and an upper surface of the stand bar are distanced from each other.

13. The support stand of claim 7, wherein the connecting member is coupled to a surface of the chassis base that is opposite to a surface of the chassis base to which the display panel is attached.

14. The support stand of claim 7, wherein the shock absorbing member is made of a rubber material.
